(19) United States
(12) Patent Application Publication
(10) Pub. No.: US 2026/0023760 A1
(43) Pub. Date: Jan. 22, 2026

(54) SYSTEMS AND METHODS OF DATA INTEGRATION

(71) Applicant: Claritype, McLean, VA (US)

(72) Inventors: Justin Streufert, McLean, VA (US); Robert Giardina, McLean, VA (US); Erik Jarleberg, McLean, VA (US); Tupshin Harper, McLean, VA (US); Jason Witenstein-Weaver, McLean, VA (US); Michael Lachmann Tamarlin, McLean, VA (US); Brian Corcoran, McLean, VA (US); Devorah Langsam, McLean, VA (US)

(73) Assignee: Claritype, McLean, VA (US)

(21) Appl. No.: 19/277,059

(22) Filed: Jul. 22, 2025

Related U.S. Application Data
(60) Provisional application No. 63/674,098, filed on Jul. 22, 2024.

(51) Int. Cl. G06F 16/28

(52) U.S. Cl. CPC G06F 16/287

(57) ABSTRACT

The systems, methods and computer implemented approaches described herein are directed to tools for data accessibility and exploration that operate by eliminating traditional data engineering delays. In particular, the described approaches accomplish this task without the necessity of generating database specific code. By way of non-limiting example, the systems and methods described are directed to the automated generation of semantic models from structured data using a plurality of machine learning and artificial intelligence technique. It will be appreciated that these machine learning and artificial intelligence tools, when combined, address a unique and difficult problem encountered in the field of database querying and management.

### CROSS-REFERENCE TO RELATED PATENT APPLICATION

The present application claims the benefit of U.S. patent application Ser. No. 63/674,098, filed Jul. 22, 2024, which is hereby incorporated by reference in its entirety.

### FIELD OF THE INVENTION

The systems, methods and computer implemented approaches described herein are directed to automated generation of semantic models for use in large scale data analysis.

### BACKGROUND

In contemporary business practice, it is imperative to leverage a comprehensive array of internal and external data sources to address analytical queries effectively. This holistic approach to data integration ensures that decision-making is informed by a broad spectrum of insights, thereby enhancing strategic and operational outcomes.

The deployment of artificial intelligence (AI) solutions necessitates the synthesis of disparate data streams into a unified framework. Modern enterprises increasingly recognize the value of AI-driven analytics in harnessing the full potential of their aggregated data repositories to generate predictive and prescriptive insights.

Business data today is typically distributed across a myriad of systems, encompassing both proprietary in-house databases and numerous third-party vendor applications. This fragmentation presents a significant challenge in achieving a cohesive data strategy, as each system often operates in isolation with its own data structure and protocols.

Each information system typically represents data in unique, and often incompatible, formats. This diversity in data representation means that no single system can provide a complete answer, necessitating sophisticated techniques for data harmonization to achieve meaningful integration and insight extraction.

One of the most resource-intensive phases of any data-driven initiative is the process of data integration and preparation. This phase, which involves cleaning, transforming, and aligning data from various sources, is essential for enabling both human analysts and AI systems to derive actionable insights. The complexity and scale of this task often result in significant expenditure of time and financial resources.

To manage the complexity of data preparation, companies must either maintain extensive internal engineering teams or rely on external service providers. These teams are tasked with the ongoing effort of data integration for each distinct application, a process that consumes a substantial portion of the IT budget.

Therefore, what is needed in the art are systems, methods and computer implemented approaches that provide automated means of harmonizing different, but related, dataset s. In particular, what is needed in the art are improvements to the field of data harmonization and consolidation with the aim of providing for rapidly and cost-effectively integrating disparate dataset s.

Furthermore, what is needed in the art are one or more efficient data management strategies that allow for the generation of semantic or other conceptual models of data and for using those conceptual models to evaluate, query and investigate disparate datasets without the time and expense of custom integration strategies.

### SUMMARY OF THE INVENTION

The systems, methods and computer implemented approaches described herein are directed to tools for data accessibility and exploration that operate by eliminating traditional data engineering delays. In particular, the described approaches accomplish this task without the necessity of generating database-specific code. By way of non-limiting example, the systems and methods described are directed to the automated generation of semantic models from structured data using a plurality of machine learning and artificial intelligence techniques. It will be appreciated that these machine learning and artificial intelligence tools, when combined, address a unique and difficult problem encountered in the field of database querying and management.

Historically, the most resource-intensive aspect of data projects has been the modeling and integration of disparate datasets into a cohesive whole. The described systems and methods leverage advanced AI to automate and streamline this process, democratizing data access and empowering users without the need for specialized data engineering skills. The described systems and methods are configured to analyze and integrate data from diverse systems and formats within minutes, facilitating intuitive human exploration and comprehension.

In one or more implementations described herein, a computer-implemented method for generating a domain-specific data model is provided, the method comprises the steps of selecting a target domain from a plurality of domains. Here, the domains can be any subject matter represented within available datasets relating to a specific domain. The method also includes performing an initial classification of data assets across multiple data sources. Here, the data assets can be databases, tables, and columns. The method further includes presenting classification results to a user via a user interface for visual inspection and correction. An additional step of re-performing the classification based on user input and additional information is also provided. Here, the additional information triggers further automated classifications. The described method also includes a step of generating a domain-specific model. The domain-specific model includes a set of concepts and mappings from the data assets to the concepts, wherein the mappings establish equivalencies between disparate datasets. A further step includes publishing the model as a versioned artifact for use in querying and visualization by downstream consumers; and iteratively updating the model in response to changes in the underlying data or the addition of new data systems.

In a further arrangement, the method described herein includes the use of a domain-specific model that is expressed in a common language. In one arrangement, the domain-specific model includes a structured representation of domain concepts and their associated mappings. In a further arrangement, the structured representations are provided in a machine-readable format.

In yet a further arrangement, the classification of data includes semantic analysis of column names, data types, and sample values to infer candidate mappings to domain concepts. In yet a further arrangement, the described method also provides for automatically detecting changes in the underlying data sources. Here, the method allows for the triggering of reclassifications and model updates without requiring manual intervention.

In one or more implementations described herein, a system for generating and utilizing domain-specific data models is provided. Here, the system comprises one or more properly configured processors configured by code executing therein to provide a semantic modeling engine that classifies and maps data from heterogeneous sources into a unified semantic graph. The system described is also configured to access or generate a traversal engine that enables cross-dataset querying by linking semantic entities. The described system further configures one or more processors to utilize, access or generate, machine learning models, including large language models, to identify semantic equivalencies and guide data transformation. In a further arrangement, the system is configured to dynamically generate a user interface that allows for interactive data exploration and visualization based on the semantic model.

Additionally, a computer-implemented process for generating semantic models from disparate data sources is provided. Such a process includes: receiving, by a data ingestion module, structured data from a plurality of heterogeneous databases, each having a distinct schema; classifying, by a machine learning model, the received data into semantic entities and relationships using a semantic modeling layer; generating, by a modeling engine, a unified semantic model by mapping the classified data to a common ontology; wherein the semantic model enables querying and exploration of the data without requiring custom code or manual integration.

### BRIEF DESCRIPTION OF THE DRAWINGS

The accompanying drawings, which are incorporated in and constitute a part of this specification, illustrate aspects of the invention and together with the description, serve to explain the principles of the invention.

FIG. 1 provides a component diagram of the presently described approaches.

FIG. 2 provides a flow diagram according to one or more processes of the described approaches.

FIG. 3 provides a module diagram utilized by one or more systems described herein.

FIG. 4 provides an example of the common language used by the presently described system.

FIG. 5 provides an example of the common language used by the presently described system.

FIG. 6 provides an alternative configuration of the presently described system.

FIG. 7 provides a view of the user interface integrated in the process described herein.

### DETAILED DESCRIPTION OF CERTAIN EMBODIMENTS OF THE INVENTION

It will be appreciated that typically, when a user wishes to query multiple datasets relating to the same domain or subject matter, there are limited options. The user can spend time and resources to combine the databases into a single dataset that can be queried. However, such a task can be expensive and time-consuming. Additionally, if the databases are active, then the user will continuously need to update this overarching database as new data is stored in the component source databases.

Over the past decades, the inventors have consistently tackled data challenges at scale. However, addressing these challenges required employing bespoke and costly systems tailored to each unique problem. Such an approach is not scalable and restricts full insight into organizational data to only those parties that are well-funded enough to commission this custom work. Here, a user can employ a number of software engineers to generate custom code that takes a query and translates the user query into several database-specific queries, combines the results of those queries and presents an output that claims to capture the necessary data. However, this approach requires extensive modeling and connecting datasets into a unified whole to permit querying of these datasets.

In contrast, the described approaches use a machine learning system to streamline this process and unlock data access for every user, without the need for data engineers. Thus, the systems described represent an improvement over the state of the art and a tangible, real-world implementation of the overall concepts described herein. Furthermore, these approaches represent non-routine, non-customary approaches to the technical problems encountered in the art.

By way of further overview and introduction, the systems, methods, and computer implemented processes described herein use one or more machine learning or artificial intelligence systems (AI) to make data rapidly accessible and explorable without the expense or delay typically associated with data engineering. In one particular implementation, these approaches represent an improvement in the fields of data management and harmonization. Specifically, the systems, methods and computer implemented processes allow users to query data from disparate datasets without needing to write custom code or interfaces between the query system and the raw data.

Indeed, the systems, methods, and computer implemented processes described herein are directed to the generation of one or more sophisticated modeling engines or agents. These modeling agents are able to swiftly transform raw data into unified, interconnected, and intelligible semantic models. This transformation occurs in minutes, which represents a substantial technical improvement over the prior art approaches. Furthermore, the described approaches allow the systems and methods described to present business users with data in aesthetically pleasing and easily interpretable formats for immediate exploration and insight generation. Furthermore, users have the ability to iteratively refine the visual configurations, crafting the optimal data views to disseminate across the organization.

The improved performance aspects of the systems and methods described are attributable, in part, to the use of one or more systems that have a core language layer or semantic modeling layer. This semantic modeling layer of the systems described is configured to generate equivalencies between disparate datasets. For instance, and in no way limiting, the systems described are able, without human intervention, to generate equivalencies between the forms of data in different systems and map them to a common language.

By way of further non-limiting example, the described system is configured to evaluate specific language, concepts or data found in a dataset. The system learns specific mappings within this dataset, such as the overlap with equivalent or corresponding data in a different dataset, and then generalizes those reasonings about the data to the entire dataset. This enables the described system to use data with disparate datasets without first hardcoding a common data format.

It will be appreciated that to permit users to query and investigate the data, the described system is configured to allow for traversal of multiple datasets to connect concepts embedded in the query to the actual raw data located in disparate databases. For example, where a user is seeking to query which marketing channels result in which vehicles being purchased, the query starts with several databases, such as a sales database, a customer database, and a marketing or business development database. These databases can then be traversed so that information about vehicles can be linked to information about purchases. From there, information about purchases can be linked to customer databases, and using the customer information, marketing channel databases can be traversed.

Additionally, the system is configured to provide an orientable set of data for a given dataset and use that orientable dataset to aid the semantic modeling systems described herein to evaluate the contents of a database.

In one or more further iterations, the systems described herein use one or more large language models or other machine learning systems to first parse data in a database into a form and format that can then be used to reconfigure the data in each dataset into a desired data record structure.

By way of example, medical professionals often have access to a number of databases, such as a patient database, a scheduling database, and an insurance database. Each of these databases may include data relating to the same person (Patient 1). However, in order to obtain harmonized data, it becomes necessary to combine the data of the three databases into a single repository. Such an undertaking can be a technical challenge and time-consuming. Existing databases can have multiple fields that are set by the user, data that includes abbreviations, or codes, or other non-standard approaches that would make it difficult to harmonize the data automatically. The processes, systems and computer implemented methods described herein are utilized to automatically harmonize this data in a manner that represents a technical improvement in the field of the data processing.

As described in more detail herein, the presently described approaches allow for the generation of semantic models that enable users to explore and query data across multiple sources without writing code. Unlike in present systems where a user would need to query different databases using each databases' often proprietary database query system, the presently described systems, methods and computer implemented processes describe mechanisms for semantic equivalency mapping, traversal-based querying, and the use of prompt tokens to guide large language models in data transformation tasks.

However, it should be appreciated that simply providing these disparate datasets to Large Language Models (LLMs) is an inelegant and fraught solution. In the first instance, Large Language Models (LLMs) are notoriously resource-intensive, requiring substantial computational power for tasks like data analysis and generation. The presently described approaches create a more efficient overall system by first using traditional software code or specialized AI algorithms to pre-process and structure the data before sending it to the LLM, if at all. This approach significantly reduces the workload on the expensive model, leading to a more streamlined and cost-effective solution.

Additionally, one of the main qualities of a LLM model is its ability to generate new content. However, in the present instance, generating new data is highly detrimental. Even systems that have a low “hallucination” or error rate are insufficient for the purposes described herein. In the provided example, it would not be acceptable for the LLM to evaluate three disparate datasets for Patient 1 and inadvertently generate a response to a query that was not present in the database.

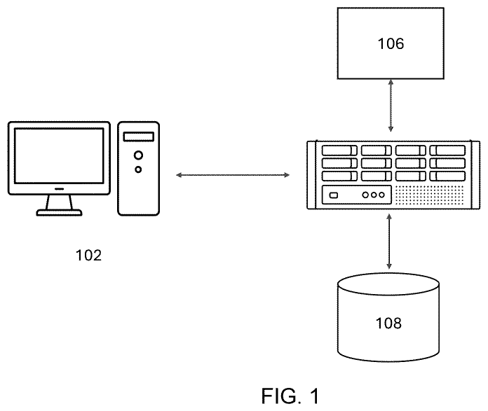

As shown in FIG. 1, a user input device 102 is configured to exchange data with a software generation server or platform 104. In one or more implementations, the user input device 102 is a smartphone, tablet computer, desktop, laptop, workstation or other computing device. In one or more arrangements, the user input device includes one or more keyboard, input devices, touch screen interfaces, voice interfaces or other known and understood interface devices. In one or more implementations, the user input device 102 is configured to communicate using one or more wired or wireless protocols, such as ethernet, WiFi and Bluetooth.

In one implementation, semantic model server 104 is a commercially available computing device. For example, semantic model server 104 may be a collection of computers, servers, cloud functions, AWS clusters, containers, microservices, microprocessors, micro-computing elements, computers-on-chip, prototyping devices, or “hobby” computing elements.

The semantic model server 104 and/or the user input device 102 are configured to execute a commercially available or custom operating system, e.g., Microsoft WINDOWS, Apple macOs, UNIX or Linux based operating system, in order to carry out instructions or code.

The semantic model server 104 and/or the user input device 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as using removable media cards or modules. In one or more embodiments, the memory of semantic model server 104 provides for the storage of application programs and data files. One or more memories provide program code that the semantic model server 104 and/or user input device 102 reads and executes upon receipt of a start, or initiation signal.

As further shown in FIG. 1, the semantic model server 104 is configured to store data either locally in one or more memory devices. Alternatively, semantic model server 104 is configured to store data, such as device data and operational data (such as training data as well as processing results) in a local or remotely accessible database 108. The physical structure of database 108 may be embodied as solid-state memory (e.g., ROM), hard disk drive systems, RAID, disk arrays, storage area networks (“SAN”), network attached storage (“NAS”) and/or any other suitable system for storing computer data. In addition, database 108 may comprise caches, including database caches and/or web caches. Programmatically, database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. Database 108 includes the necessary hardware and software to enable processor 108 to retrieve and store data within database 108.

As also shown in FIG. 1, a machine learning appliance 106 is also provided. In one or more implementations, the machine learning appliance 106 is a locally controlled or constructed large language model. In another implementation, the machine learning appliance 106 is a remote server, software system, computing group or cluster that provides access to one or more AI systems. For example, in one or more implementations, the machine learning appliance 106 is accessible by the semantic model server 104 through one or more application programming interfaces (API). For example, the machine learning appliance 106 is a server operated by OpenAI, Google, Meta or another provider of AI as a service.

In addition to the aforementioned configurations, the machine learning appliance 106 can be integrated with various data processing modules to enhance its functionality. These modules may include data pre-processing units, feature extraction tools, and model evaluation components. The integration of these modules allows the machine learning appliance 106 to perform complex data analysis tasks, thereby improving the accuracy and efficiency of the AI systems it supports.

Furthermore, the machine learning appliance 106 can be configured to support real-time data processing and analysis. The appliance's ability to handle large volumes of data in real-time ensures that it can meet the demands of high-performance computing environments.

Moreover, the machine learning appliance 106 is designed with scalability in mind. It can be easily scaled up or down based on the computational requirements of the AI systems it supports. This flexibility ensures that the appliance can adapt to varying workloads and maintain optimal performance levels. Additionally, the appliance can be deployed in a distributed manner, allowing multiple instances to work together seamlessly, thereby enhancing its overall processing power and reliability.

In one particular implementation, the machine learning appliance 106 includes a natural language processor. For example, the natural language processor is configured to receive textual input from the semantic model server 104 and evaluate the textual input for the purpose of analyzing and extracting meaning and information from the textual input. For example, and in no way limiting, data such as text or voice data provided by the user input device 102 can be routed to the machine learning appliance 106 for further evaluation and analysis.

In one or more arrangements, the machine learning appliance 106 includes one or more large language models. It will be understood that as used herein, large language models (LLMs) are machine learning models that can be trained on dataset s of content to generate flexible customized outputs suitable for a number of tasks, including generating software code, creative or informative text, images, or data. In particular, various implementations described herein provide one or more large language models (LLMs) for a variety of different natural language processing (NLP)-related tasks, such as generating content for integration into a software manifest file or document.

In one or more further implementations, the machine learning appliance 106 is configured to be adaptable for use with a variety of tasks such as generating custom software modules, JSON data, API calls, code documentation, and content for integration into manifest files without a need to retrain the core or base model or use multiple different, customized models. For example, the LLMs provided by the machine learning appliance 106 are configured such that custom or individual prompting guidance provides for a focused context for the LLM to operate. Here, such prompting guidance can include one or more token, tag, weight, file, modifier, or other type of data object that can be added to, embedded in, or associated with a request to perform a specific operation, or type of operation, with respect to a string of text.

As a non-limiting example, prompt tokens can be used to train or instruct the LLM to indicate the nature of the operation to be performed, retrieval set tags can be supplied to the LLM to indicate a dataset to use for the operation, and/or adaptor weights can be used that can effectively modify operation or structure of the language model. In one or more further arrangements, the machine learning appliance 106 includes software utilized to set these prompt tokens, or otherwise retrieve and pre-process data for submission to the LLM as well as receiving and transmitting the output.

Returning to the overview, each element provided in FIG. 1 is configured to communicate with the others through network connections or interfaces, such as a local area network (LAN) or data cable connection. In an alternative implementation each of the elements depicted are connected to a network, such as the internet, and are configured to communicate and exchange data using known and understood communication protocols.

Those possessing an ordinary level of skill in the requisite art will appreciate that additional features, such as power supplies, power sources, power management circuitry, control interfaces, relays, adaptors, and/or other elements used to supply power and interconnect electronic components, and control activations are appreciated and understood to be incorporated.

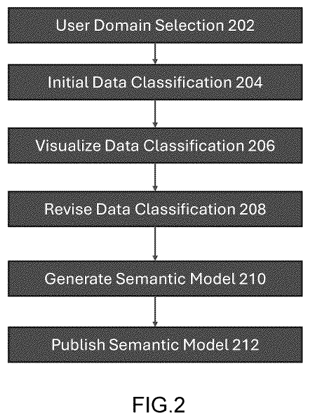

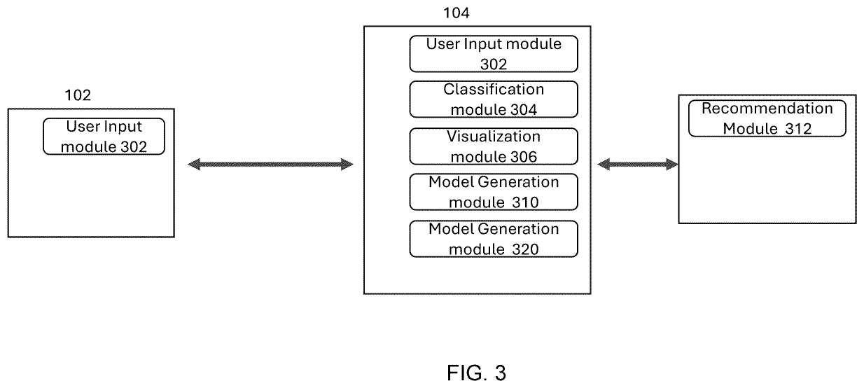

Thus, turning now to FIG. 2-3, a system, method and computer-implemented process for generating a domain-specific data model is provided.

As shown in step 202, the user of the system described is provided with a prompt that permits the selection of a target domain from a plurality of domains. Here, the domains can be any subject matter represented within available datasets relating to a specific domain. In keeping with the prior example, the target domain is patent records. In one or more implementations, a user device 102 is configured by code executing therein to send one or more data structures, files, content, text or other data to the semantic model server 104. By way of non-limiting example, the user device 102 is configured by a user input module 302 to provide the semantic model server 104 with access to the various domain specific datasets. For example, the domain datasets can be a CRM dataset that contributes the customer name, address, and email for a patient; a marketing dataset that contributes information about how to contact the customer for future offers (email, web advertisement, through a partner) and a transaction dataset that contributes the total of the customers' bills or purchases. In one arrangement, the data for each of the domains are stored within the database 108. In one particular implementation, the user input device is configured to instruct the semantic model server 104 to query one or more databases 108 for data relating to the domain of interest. In a particular implementation, the datasets are located in a local database 108. However, in an alternative configuration, the datasets are located in a plurality of remote databases or a combination of local and remote databases.

Once the semantic model server 104 has been provided with access to the dataset s, one or more processors of the semantic model server 104 are configured by code executing therein to perform an initial classification of the data contents across the different provided domains as shown in step 204. In one arrangement, a processor of the semantic model server 104 is configured by one or more classification modules 304 to classify the data contained within the accessed data sources. In one arrangement, the classification module 304 configures the processor of the semantic model server 104 to perform an initial classification of data assets across multiple data sources. For example, the semantic model server 104 is configured to access databases, tables, and columns in each of the data assets.

Without limiting the scope of the disclosure provided herein, in one or more implementations the classification step 204 includes utilizing one or more classification models to classify the data in the data assets. For example, the classification module 304 configures the semantic model server 104 to evaluate and classify raw data using an ensemble of classification algorithms. It will be appreciated that not all classification algorithms are suitable for all data types of domains. Therefore, the classification module 304 configures the processor by one or more pre-processors to identify the structure of the datasets of interest and determine which of the ensemble of classification algorithms are to be applied to the domain data.

However, in an alternative configuration, the classification module 304 configures the semantic model server 104 to apply each of the ensemble classification algorithms to the domain of interest (retail, transportation, healthcare).

In one or more implementations, the semantic model server 104 is configured to apply the following classification algorithms to the datasets, Random Forest classifiers (which can be used to reason about a sample of the data, once for each column. The semantic model server 104 can also use one or more Lexical classifiers in order to classify columns based on the name of each column, adjacent columns, and containing table and database names. Additionally, Symbol classifiers can also be used to evaluate the dataset. Here, symbol classifiers are used to evaluate the data and based on the data, determine if values are of a well-known type of symbol (month names, priorities, genders, etc.). Furthermore, one or more historical context classifiers are used. Here, these classifiers are used to classify the data in the datasets according to columns and data that have been seen previously.

In one or more implementations, the classifier algorithms each generate multiple selections from a range of possible values. In one non-limiting example, the output of the classifiers are represented as a probability of the existence of certain concepts within the data (eg: a Person, or Vehicle). In a further arrangement, the output of the classifiers also relates to the probability of the assignments of certain data columns to those concepts (eg: Person.name vs Vehicle.name), conditional on one or more prior determinations. In one arrangement, these prior determinations are the initial probability that certain concepts are present within the data.

As described in more detail herein, one or more conflict resolution modules are used to determine if there is sufficient combined evidence for the conflicting concepts in the first pass of classifications. In one or more further arrangements, the conflict resolver evaluates the data as accurately classified by the classifiers, and determines what the assignments of the data columns (from all contributing datasets) to those concepts would be if the classification was accurate. However, it will be appreciated that the described approach is iterative, so that the concepts identified initially by the classifier can be reevaluated in light of the quality and completeness of the overall assignment of all columns to concepts.

In yet a further implementation, the data is classified using one or more large language models. In either configuration, the classifiers (either LLM or algorithm based) are accessible through the AI appliance 106. In this configuration, data is exchanged between the semantic model server 104 and the AI appliance 106. In this configuration, the AI appliance can be updated or revised and provide a suite of classification options to the semantic model server 104. In one arrangement, the semantic model server 104 and the AI appliance are configured to exchange data using one or more custom application programming interfaces (APIs). For example, the semantic model server 104 is configured by code to request from the AI appliance 106 a list of available classifiers. For example, the AI Appliance utilizes one or more machine learning systems to recommend specific classifiers given the domain of the data under evaluation using a recommendation module 312.

It will be appreciated that each of the classification algorithms will generate an output that corresponds to the type or nature of the data contained within the dataset. The described systems, methods, and computer implemented processes create semantic models from structured data by using an ensemble of classification algorithms and heuristics to match known patterns and data distributions to connected data models that represent well-known concepts from the business world. These classifications identify the meaning of the underlaying data while also normalizing the data's formats to conform with common standards, thus creating a unified semantic model that is independent of the system of origin.

It will be appreciated and understood that additional classification algorithms suitable for the purposes and functionality described herein are envisioned. Furthermore, it will be appreciated by those possessing an ordinary level of skill in the requisite art that the described classification algorithms, as well as other classification algorithms can be used in conjunction to evaluate the data.

Once the initial data has been classified, according to one or more classification algorithms, the semantic model server 104 is configured to evaluate the signals generated by each of the classification algorithms. Each of the classification algorithms are used to determine the nature of the data within a given dataset. For example, the lexical and random forest classifiers are both used to classify the CMS dataset. The lexical classifier generates a signal indicating that the dataset contains data about customers, their addresses and electronic communication data. Alternatively, the random forest classifier could evaluate the same CMS dataset and determine that the data contained therein is marketing data. Now, these two classifiers are in conflict regarding the nature of the data in the dataset. Therefore, in one or more implementations, a conflict resolution algorithm is utilized to weight the potentially conflicting signals generated by the classification algorithms. In one or more implementations, the semantic model server 104 is configured by the classifier module 304 to implement a pre-trained machine learning model that is configured to evaluate the outputs of the various applied classification algorithms and weight the signals from the classifiers. For instance, there is a proprietary reasoner that is trained in the domain of interest to combine and weight the (possibly conflicting) signals from the classifiers above.

In various embodiments, adjudicating conflicting determinations from a plurality of autonomous classifier algorithms operating on a given dataset can be handled using a resolution module. In one arrangement, such a resolution module is a sub-module of the classification module 304. However, in one or more arrangements such a resolution module is an independent module 320. In one arrangement this resolution module 320 functions as a meta-learning or stacking ensemble. This module is configured to receive, as input, the prediction outputs generated by two or more base classifiers for a specific data instance. The conflict resolution module processes these inputs to generate a single, authoritative final classification, thereby resolving any discrepancies between the base classifiers and improving the overall accuracy and reliability of the system. This architecture allows for the flexible integration of diverse base classifiers, leveraging their collective strengths while mitigating their individual weaknesses.

In one embodiment, the conflict resolution module may be implemented using a variety of machine learning models. For instance, the module may employ a weighted voting or averaging scheme, wherein each base classifier is assigned a static weight corresponding to its empirically measured performance on a validation dataset. In a more sophisticated embodiment, the module may utilize a logistic regression model, which learns an optimal linear weighting of the base classifier outputs to maximize predictive accuracy. Alternatively, the module can be implemented as a Support Vector Machine (SVM), which determines a non-linear decision boundary within the high-dimensional space of the collective classifier predictions to arrive at a final determination.

In other embodiments, the conflict resolution module may be configured to learn complex, non-linear relationships between the base classifier outputs. One such embodiment utilizes a neural network architecture, such as a Multi-Layer Perceptron (MLP). The input to this neural network may be a concatenated vector comprising both the prediction vector from the base classifiers and a semantic feature embedding of the original data instance, said embedding being generated by a separate, pre-trained model. This configuration enables the system to learn context-specific trust, dynamically weighing the base classifiers based on the subject matter of the data instance itself. In another embodiment, the system employs a latent trait model, which statistically infers the distinct reliability of each classifier and the inherent ambiguity of each data instance, using these inferred parameters to compute the most probable correct classification. Further embodiments may utilize tree-based ensemble models, such as Gradient Boosted Trees, to serve as the meta-learner.

Therefore, the semantic model server 104 is configured by code to combine conflicting evidence into a final classification of the data contained within the datasets.

As shown in step 206, once the data classification (and potential conflict resolution) has been accomplished, the semantic model server 104 is configured by a visualization module 306 to present to the user input device 102 the determined classification results. Here, the user of the user input device 102 can visually inspect the generated data and provide updates or corrections to the data classification.

In one or more further steps, as shown in step 208, the receipt of user's data by the semantic model server 104 causes the classification step 204 to be carried out again. For example, the semantic model server 104 is configured to perform the data classification steps again, using based on user input and additional information is provided in step 206. Here, the additional information triggers further automated classifications.

Once the data from the multiple discrete data sources has been generated, the data can be used to build the semantic model. As shown in step 210, the semantic model server 104 is configured to generate a domain-specific model of the data contained within the distinct data sources. In one arrangement, the semantic model server 104 is configured by a model generation module 310. The properly configured semantic model server 104 generates a domain specific (semantic model) that provides a mapping of the data classified by the classification algorithms. In particular, the generated semantic model includes a set of concepts and mappings from the data assets to the concepts, wherein the mappings establish equivalencies between disparate datasets. For instance, and in no way limiting, the semantic model server 104 is configured to, without human intervention, generate equivalency between the forms of data in different systems and map them to a common language. As used herein, this common language is primarily a list of the concepts in the domain, and the mappings from all of the input systems data (the various data sources) to those concepts. To return to the previous example, a CRM, a marketing system, and a transaction system may all know independent fragments about a given Customer. The mapping language combines the contribution of each of these systems to the combined view of the Customer. Thus, the semantic model provides access to the data using a common language that enables users (such as a user of the input device 102) to be able to access all of the information about that Customer. In fact, the user is able to obtain this unified view of the data without explicitly needing to know which databases have been classified, or needing to generate custom code to query each of the disparate databases. The semantic model, in this instance, is a data structure that acts as a map for the execution of algorithms.

Turning now to step 212, once the semantic model has been generated as in step 210, the semantic model server 104 is configured to publish the model as a versioned artifact for use in querying and visualization by downstream consumers. For example, the user of the user input device 102 is able to access and query the semantic model using the common language and iteratively updating the model in response to changes in the underlying data or the addition of new data systems. In one or more specific implementations, a software modeling engine is configured to transform raw data into unified, connected, and understandable semantic models. As used herein, semantic models refer to models implemented in code that map the relationships between concepts and entities, often utilizing ontologies, which are structured frameworks that define the relationships between different terms and concepts in a particular domain.

Through the use of these semantic models, users can evaluate data easily and without extensive reliance on complex software to harmonize data from different datasets. Thus, the described approach allows for a significant improvement in terms of functionality. Data can be ready for users to evaluate within minutes, compared to days and dozens of man-hours of programming work under prior approaches.

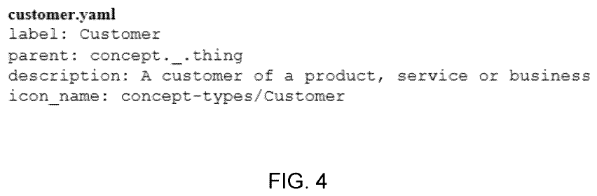

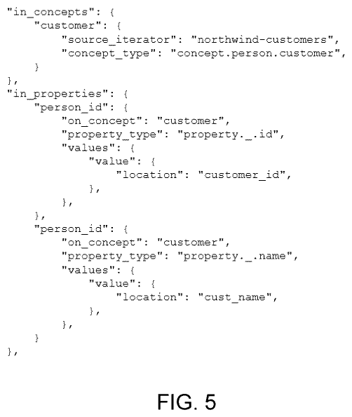

As shown in FIGS. 4-5, the common language transforms a user's query and maps that query onto the actual data sources provided. As shown in FIG. 4, a user can query information about the customer using the common language label (Customer). As shown in FIG. 5, this query can then be mapped to the underlying data sources (referred to in part by the source_iterator field). Thus, when a user queries information about the customer, the mapping common language is used to traverse each of the datasets and surface the relevant data to the query.

In one implementation, each element provided in FIG. 2-3 can be implemented, in one or more arrangements, as a separate system or processor, or alternative sub-processing elements within the same computing environment. Where the functions carried out are carried out by non-local computing platforms, such platforms can communicate with one another through network connections or interfaces, such as the internet or specific local area networks. In an alternative implementation, each of the systems configured to carry out the depicted functions are connected to a network, such as the internet, and are configured to communicate and exchange data using commonly known and understood communication protocols.

In contrast, by processing the datasets and generating a semantic model, the described approach provides for a system that is more accurate and less computationally expensive relative to existing systems.

The described systems allow users to connect disparate data gathered in their data repositories (such as a data warehouse or data lake) (accessed from the databases 108) and explore all available data to gain insights based on new or existing patterns. When used in connection with a real-world industry, such as car dealerships, the described system allows users to search for specific data answers, e.g., read about a customer and their history, and use this information to answer new questions that combine datasets, e.g., which marketing channel results in the purchase of which vehicles.

It will be appreciated that further implementations of the described systems are envisioned to include one or more common software languages. For example, the domain-specific model can be expressed in a common language comprising a structured representation of domain concepts and their associated mappings, the structured representation being in a machine-readable format such as JSON or YAML.

Likewise, the described approaches include semantic analysis of column names, data types, and sample values to infer candidate mappings to domain concepts.

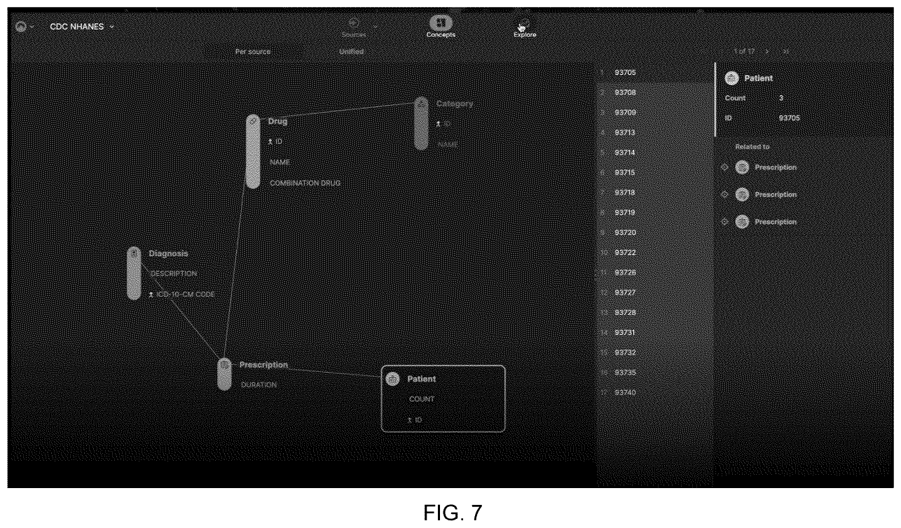

In yet a further implementation, the system described is configured to dynamically generate one or more user interfaces. These dynamically generated user interfaces enable drag-and-drop or point-and-click interactions to refine or override automated classifications. In one arrangement, code instructing the user device 102 is generated by the semantic model server 104 and transmitted to the user input device 102 for display. Based on user input and manipulation of the user interface elements, the semantic model server 104 is configured to dynamically update the user display in response to user input, as shown in FIG. 7.

It will be further appreciated that the system automatically detects changes in the underlying data sources and triggers reclassification and model updates without requiring manual intervention. These changes are then used to automatically update the display provided to the user.

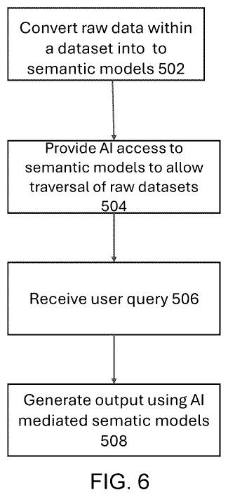

In yet further implementations of the subject matter described herein, one or more machine learning applications or appliances can be integrated into the processes described. For example, AI modules or models can accomplish the desired interactivity with the raw data stored in the disparate datasets, as illustrated in FIG. 6.

As shown in FIG. 6, in a first step, raw data in one or more databases are classified into Semantic Models without code as shown in step 502. In one or more implementations, a machine learning model (such as but not limited to a large language model) is provided with the contents of the database, and the LLM traverses the contents of the database to build a semantic model of that database that can then be used for further analysis. For example, independent contextual AI agents are used for data discovery and organization of that data into semantic models. This approach also allows for smart assembly and/or self-assembly across disjointed and potentially conflicting semantics. However, in one or more further arrangements, the semantic models are generated using the processes described in steps 202-206.

Once the semantic model is generated, a pre-trained machine learning system, such as an LLM, neural network, natural language processor, diffusion model, or other system, is used to query and access the semantic models so as to interact with the data, as shown in step 504. For example, the AI systems described (such as AI systems hosted in the AI Appliance 106) are used to explore the data represented by the semantic models. Thus, a user query, as shown in step 504 is used to supply a LLM or other AI system with the requirements of the user. The LLM or other AI system takes this input and uses one or more specifically provisioned AI agents to query the semantic models and generate the responses to the user. For example, the AI agents can surface the relevant data, which the LLM then takes and formats into preferred or expected visual formats, as shown in step 508. It is appreciated that in one or more arrangements, the machine learning agents or models described herein include one or more large language models. It is understood that as used herein, large language models (LLMs) are machine learning models that can be trained on datasets of content to generate flexible customized outputs suitable for a number of tasks, including generating creative or informative text, images, or data. In particular, various implementations described herein provide one or more large language models (LLMs) for a variety of different natural language processing (NLP)-related tasks, such as evaluating content within a database and undertaking reasoning thereof. In one or more further implementations, the machine learning agents or models described herein are configured to be adaptable for use with a variety of tasks such as evaluating the semantic relationship of data within a dataset without needing to retrain the core or base model or use multiple different, customized models. For example, the LLMs or other machine learning appliances or agents described herein are configured such that custom or individual prompting guidance provides a focused context for the LLM to operate. Such prompting guidance can include one or more tokens, tags, weights, files, modifiers, or other types of data objects that can be added to, embedded in, or associated with a request to perform a specific operation, or type of operation, with respect to a string of text.

This merger of both AI agents, LLMs and algorithmic classifications allows for datasets to be interactively explored across a fully connected data enterprise, without code. In one instance, the merging of semantic models across data sources is done by identifying overlapping values within the data sources.

Thus, the presently pending approach offers a solution that focuses on the core problem of unifying the meaning of data across any format variation. This unification is the critical element that allows future Als to reason about data based on its precise meaning/definitions, with verifiable and measurable results.

When taken together, the described system and methods are directed to evaluating the raw data found in a dataset. The described system and methods implement one or more computer or software systems that learn specific mappings within this dataset, such as to equivalent or corresponding data in a different dataset and then generalize those reasonings about the data to the entire dataset. This enables the described system to learn the mapping and usage of the data. Additionally, a user or planner is configured to provide an orientable set of the data to put it in the format that the semantic modeling systems described herein use. In one or more further iterations, the described systems use one or more large language models or other machine learning systems to first parse data in a database into a form and format that can then be used to reconfigure the data in each dataset into a desired data record structure.

The foregoing description of specific embodiments reveals the general nature of the disclosure so fully that others can, by applying knowledge within the skill of the relevant art(s) (including the contents of the documents cited and incorporated by reference herein), readily modify and/or adapt these specific embodiments for various applications, without undue experimentation, and without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for description purposes and not of limitation, so the terminology or phraseology of the present specification is to be interpreted by the skilled artisan in light of the teachings and guidance presented herein, in combination with the knowledge of one skilled in the relevant art(s).

In one or more further embodiments of the systems processes and computer implemented processes described herein, a system for querying across multiple disjointed datasets is provided. This system comprises a semantic model generator configured to produce semantic models for each dataset; a traversal engine configured to identify and follow relationships between semantic entities across the semantic models; a query interface configured to receive a user query and return results by traversing the semantic models across at least two datasets; wherein the traversal engine enables the system to answer queries that require linking data across semantically distinct sources.

In one or more further embodiments of the systems, processes and computer implemented methods described herein include a method for establishing semantic equivalency between datasets using machine learning, comprising: parsing, by a large language model (LLM), a first dataset to identify data structures and contextual meaning; identifying, by the LLM, equivalent or corresponding data structures in a second dataset; generating, by the LLM, a mapping between the first and second datasets based on learned semantic relationships; wherein the mapping enables integration of the datasets without requiring a predefined common schema.

In one or more further embodiments of the systems, processes and computer implemented method described herein includes a system for interactive data exploration, comprising: a semantic model merger model configured to combine semantic models generated from multiple datasets into a unified semantic graph; a visualization interface configured to present the unified semantic graph to a user; a query processor configured to interpret user queries and retrieve relevant data from the unified semantic graph; wherein the system allows a user to explore and analyze data from multiple sources without writing code or performing manual data transformation.

In one or more further embodiments of the systems, processes and computer implemented method described herein includes a method for guiding a large language model (LLM) to parse and reconfigure data from a dataset, comprising: generating one or more prompt tokens, retrieval set tags, or adaptor weights associated with a target data operation; providing the prompt tokens to the LLM along with a dataset; parsing, by the LLM, the dataset into a structured format suitable for semantic modeling; wherein the prompt tokens provide contextual guidance to the LLM to perform a specific data transformation task.

It will be appreciated that any of the elements described in a given system, method or process can be utilized in connection or conjunction with another element described in a different system, method or computer implemented process described herein. Various combinations of the elements described herein may be combined in multiple configurations and arrangements.

Any patents, patent applications, publications, or other references are herein incorporated by reference as if each was presented in its respective entirety.

The terminology used herein is for describing particular embodiments only and is not intended to limit the invention. As used herein, the singular forms “a”, “an”, and “the” are intended to include the plural forms as well, unless the context clearly indicates otherwise.

1. A computer-implemented method for generating a domain-specific data semantic model, comprising:
selecting a target domain dataset;
performing an initial classification of target domain dataset;
presenting classification results to a user via a user interface for visual inspection and correction;
generating a domain-specific model comprising a set of concepts and mappings from the data assets to the concepts, wherein the mappings establish equivalencies between disparate datasets;
publishing the model as a versioned artifact for use in querying and visualization by downstream consumers; and
iteratively updating the model in response to changes in the underlying data or the addition of new data systems.

2. The method of claim 1, wherein the target domain dataset includes at least tabular data.

3. The method of claim 1, wherein the target domain dataset includes a plurality of databases relating to the target domain.

4. The method of claim 3, wherein the initial classification of the target domain dataset includes evaluating data across the plurality of databases.

5. The method of claim 1, further comprising the step of performing an additional classification of the datasets based on user input after the initial classification, wherein the additional classifications are preformed automatically in response to receiving user input.

6. The method of claim 1, wherein the classification is implemented using one or more classification algorithms.

7. The method of claim 6, wherein the initial classification is implemented using one or more of random forest classifier; lexical classifier, symbol classifier, and historical context classifier.

8. Ther method of claim 6, further comprising receiving from each of the one or more classification algorithms, one or more values that represent the probability of the existence of one or more pre-determined concepts within the dataset.

9. Ther method of claim 8, further using the calculated probability of the existence of one or more pre-determined concepts within the dataset classifying at least a portion of the data as referring to the one or more pre-determined concepts.

10. The method of claim 1, wherein the classification is implemented using one or more large language model configured to receive the dataset.

11. The method of claim 1, wherein the domain-specific model is expressed in a common language comprising a structured representation of domain concepts and their associated mappings.

12. The method of claim 1, wherein the classification includes semantic analysis of column names, data types, and sample values to infer candidate mappings to domain concepts.

13. The method of claim 1, wherein the user interface enables drag-and-drop or point-and-click interactions to refine or override automated classifications.

14. The method of claim 1, wherein the system automatically detects changes in the underlying data sources and triggers reclassification and model updates without requiring manual intervention.

15. (canceled)

16. (canceled)

17. (canceled)

18. A data transformation pipeline implemented by one or more processors for semantic unification, the pipeline comprising:
a format normalization module configured to convert input data from various formats into a common intermediate representation;
a semantic mapping engine configured to map normalized data to predefined semantic constructs;
a conflict resolution module configured to detect and reconcile inconsistencies in semantics across datasets;
wherein the pipeline outputs a unified semantic model suitable for downstream AI analysis or business intelligence applications.

19. A system for generating training datasets for machine learning models from multiple, semantically disjointed databases, comprising:
a semantic extraction module configured to identify relevant features and labels from each database;
a harmonization engine configured to align extracted features across databases with differing schemas and semantics;
a training data generator configured to output labeled datasets suitable for supervised learning tasks;
wherein the system enables scalable and repeatable generation of high-quality training data without manual data engineering.
